(19) United States
(12) Patent Application Publication
(10) Pub. No.: US 2017/0293550 A1
(43) Pub. Date: Oct. 12, 2017

(54) APPARATUS AND METHOD FOR TESTING INTEROPERABILITY OF ROBOT SOFTWARE

(71) Applicant: ELECTRONICS AND TELECOMMUNICATIONS RESEARCH INSTITUTE, Daejeon (KR)

(72) Inventor: Byoung-Youl SONG, Daejeon (KR)

(73) Assignee: ELECTRONICS AND TELECOMMUNICATIONS RESEARCH INSTITUTE, Daejeon (KR)

(21) Appl. No.: 15/465,875

(22) Filed: Mar. 22, 2017

(30) Foreign Application Priority Data
Apr. 8, 2016 (KR) 10-2016-0043310

(51) Int. Cl. G06F 11/36

(52) U.S. Cl. CPC G06F 11/3684; G06F 11/3688; G06F 11/3608

(57) ABSTRACT

Disclosed are an apparatus and method for generating a scenario for testing interoperability of robot software. The apparatus for generating a scenario for testing interoperability of robot software includes a user interface unit for receiving a request to test a component under test from a user, a semantic model-mapping unit for mapping a test case semantic model to the component under test, a test scenario template selection unit for selecting a test scenario template corresponding to a type of the component under test, a test case component selection unit for selecting a test case component based on whether the mapped test case semantic model corresponds to a source or a target, and an interoperability test scenario generation unit for generating an interoperability test scenario based on information about a connection between the component under test and the test case component in the selected test scenario template.

### CROSS REFERENCE TO RELATED APPLICATION

This application claims the benefit of Korean Patent Application No. 10-2016-0043310, filed Apr. 8, 2016, which is hereby incorporated by reference in its entirety into this application.

### BACKGROUND OF THE INVENTION

### 1. Technical Field

The present invention relates generally to technology for generating a scenario for testing the interoperability of robot software, and more particularly to technology for generating an interoperability test scenario in consideration of the use and type of software components and software component ports.

### 2. Description of the Related Art

In the case of robot software, multiple components or modules are coupled so as to configure a single robot, or each component or module performs a function of a robot. Accordingly, software components must be compatible with each other and interwork in the development and management steps, and to this end, interoperability must be guaranteed.

Also, in order to continue to use already developed software components (SWC) when robot hardware, such as an MCU or the like, is replaced, software components need to have a hardware-independent structure. Also, it is necessary to test interworking between the hardware and the independent software components via a virtual network, and to test whether the software components can be reused.

Here, interoperability represents linkage and compatibility for enabling software components to interact with each other without a special configuration. Also, a test for checking whether such interaction is performed normally with respect to interoperability is called an interoperability test. In order to maximize the effects of an interoperability test, it is necessary to test interoperability with a large number of software components.

According to a conventional art, an interoperability test scenario may be generated by an automated tool. However, because a software component to be tested must be selected by a person who conducts testing, and because the selection is difficult to automate, it is problematic in that it takes a lot of time and effort to test a large number of software components.

Accordingly, it is necessary to solve the problem with the existing technology in which the generation of an interoperability test scenario depends on human resources, and to develop technology for automatically selecting different robot software components on which an interoperability test can be performed.

Also, urgently required is the development of technology for generating a scenario for testing the interoperability of robot software components, in which information about a connection between ports, set based on the data type of the software components and the use of the ports, is automatically included. In connection with this, Korean Patent Application Publication No. 10-2015-0049009 discloses a technology related to “Method and apparatus for automation of smart grid common information model interoperability test.”

### SUMMARY OF THE INVENTION

An object of the present invention is to enable robot software components, on which an interoperability test may be performed, to be automatically selected.

Another object of the present invention is to automatically generate a scenario for testing the interoperability of robot software component, in which information for setting a connection between the ports of the software components is automatically included.

A further object of the present invention is to improve the efficiency of the use of time and human resources required for an interoperability test performed on a large number of software components.

In order to accomplish the above objects, an apparatus for generating a scenario for testing interoperability of robot software according to the present invention includes a user interface unit for receiving a request to test a component under test from a user; a semantic model-mapping unit for mapping a test case semantic model to the component under test; a test scenario template selection unit for selecting a test scenario template corresponding to a type of the component under test; a test case component selection unit for selecting a test case component based on whether the mapped test case semantic model corresponds to a source or a target; and an interoperability test scenario generation unit for generating an interoperability test scenario based on information about a connection between the component under test and the test case component in the selected test scenario template.

Here, the sematic model-mapping unit may map the test case semantic model, corresponding to types of the component under test and an input/output port of the component under test, to the component under test.

Here, the test scenario template may include a connection between a semantic port of the test case sematic model, mapped to the component under test, and a semantic port of a test case semantic model corresponding to the test case component.

Here, the test scenario template selection unit may select the test scenario template when a type of the component under test is identical to a type of a component corresponding to a source in the test scenario template.

Here, the test scenario template selection unit may select the test scenario template when a type of the component under test is identical to a type of a component corresponding to a target in the test scenario template.

Here, the test case component selection unit may select the test case component corresponding to the source when the test case semantic model mapped to the component under test corresponds to the target in the test scenario template.

Here, the test case component selection unit may select the test case component corresponding to the target when the test case semantic model mapped to the component under test corresponds to the source in the test scenario template.

Here, the interoperability test scenario may be generated by connecting the component under test with the test case component in the selected test scenario template.

Here, the component under test may be mapped to the one or more test case semantic models.

Here, the interoperability test scenario generation unit may generate a script including instructions for executing the generated interoperability test scenario.

Also, a method for generating a scenario for testing interoperability of robot software, performed by an apparatus for generating a scenario for testing interoperability of robot software, according to an embodiment of the present invention includes receiving a request to test a component under test from a user; mapping a test case semantic model to the component under test; selecting a test scenario template corresponding to a type of the component under test; selecting a test case component based on whether the mapped test case semantic model corresponds to a source or a target; and generating an interoperability test scenario based on information about a connection between the component under test and the test case component in the selected test scenario template.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram that shows the configuration of an apparatus for generating a scenario for testing the interoperability of robot software according to an embodiment of the present invention;

FIG. 2 is a flowchart for explaining a method for generating a scenario for testing the interoperability of robot software according to an embodiment of the present invention;

FIG. 3 is a view for explaining the operation mechanism of an apparatus for generating a scenario for testing the interoperability of robot software according to an embodiment of the present invention;

FIG. 4 is a view for explaining a semantic model and a semantic model description file according to an embodiment of the present invention;

FIG. 5 is a view for explaining the relationship between a test case semantic model and a component under test according to an embodiment of the present invention;

FIG. 6 is a view for explaining the mapping file of a component under test according to an embodiment of the present invention;

FIG. 7 is a view for explaining the connection of test case semantic models according to an embodiment of the present invention;

FIG. 8 is a view for explaining a test case semantic model description file and a test scenario template according to an embodiment of the present invention;

FIG. 9 is a view for explaining the operation of an apparatus for generating an interoperability test scenario according to an embodiment of the present invention; and

FIG. 10 is a block diagram that shows a computer system according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated in order to make the description clearer.

Hereinafter, a preferred embodiment according to the present invention will be described in detail with reference to the accompanying drawings.

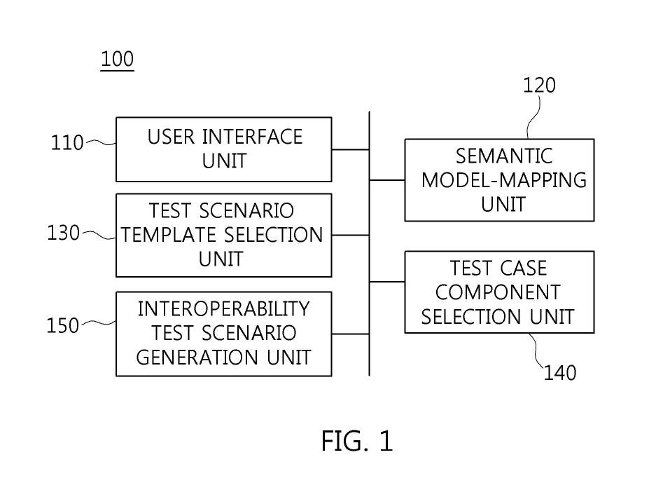

FIG. 1 is a block diagram that shows the configuration of an apparatus for generating a scenario for testing the interoperability of robot software according to an embodiment of the present invention.

As illustrated in FIG. 1, the apparatus 100 for generating an interoperability test scenario includes a user interface unit 110, a semantic model-mapping unit 120, a test scenario template selection unit 130, a test case component selection unit 140, and an interoperability test scenario generation unit 150.

First, the user interface unit 110 receives a request to test a component under test from a user. Here, the component under test may be mapped to one or more test case semantic models.

The semantic model-mapping unit 120 maps the component under test to a test case semantic model when the request to test the component under test is received. Here, the semantic model-mapping unit 120 may map the component under test to a test case semantic model corresponding to components whose function is the same as or similar to that of the component under test.

The semantic model-mapping unit 120 may map the component under test to a test case semantic model, corresponding to the types of the component under test and the input/output port of the component under test.

Next, the test scenario template selection unit 130 selects a test scenario template corresponding to the type of the component under test.

Here, the test scenario template may include a connection between the semantic port of the test case semantic model mapped to the component under test and the semantic port of a test case semantic model corresponding to a test case component.

Also, the test scenario template selection unit 130 may select a test scenario template when the type of the component under test is the same as the type of a component corresponding to a source in the test scenario template. Also, the test scenario template selection unit 130 may select a test scenario template when the type of the component under test is the same as the type of a component corresponding to a target in the test scenario template.

Also, the test case component selection unit 140 selects a test case component based on whether the test case semantic model mapped to the component under test corresponds to a source or a target.

When the test case semantic model mapped to the component under test corresponds to a target in the test scenario template, the test case component selection unit 140 may select a test case component corresponding to a source. On the other hand, when the test case semantic model mapped to the component under test corresponds to the source in the test scenario template, the test case component selection unit 140 may select a test case component corresponding to the target.

Finally, the interoperability test scenario generation unit 150 generates an interoperability test scenario based on information about the connection between the component under test and the test case component in the selected test scenario template.

Here, the interoperability test scenario may be generated by connecting the component under test with the test case component in the selected test scenario template.

Also, the interoperability test scenario generation unit 150 may generate a script that includes instructions for executing the generated interoperability test scenario. Also, the interoperability test scenario generation unit 150 may generate a test case application package profile corresponding to the generated interoperability test scenario.

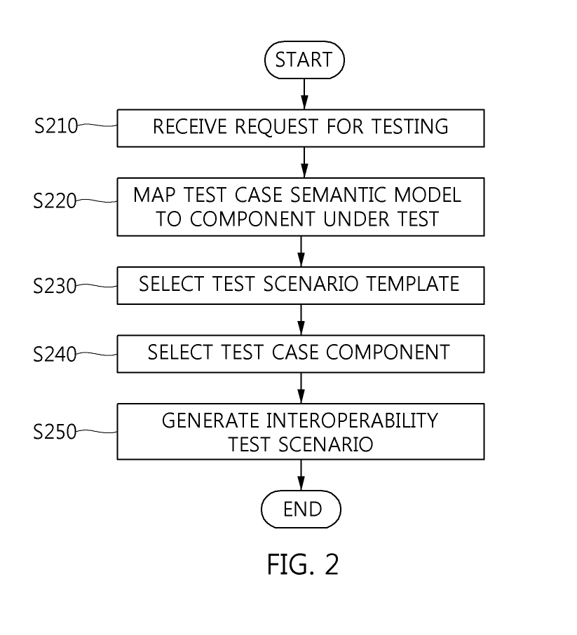

Hereinafter, a method for generating a scenario for testing the interoperability of robot software according to an embodiment of the present invention will be described in detail with reference to FIGS. 2 to 8.

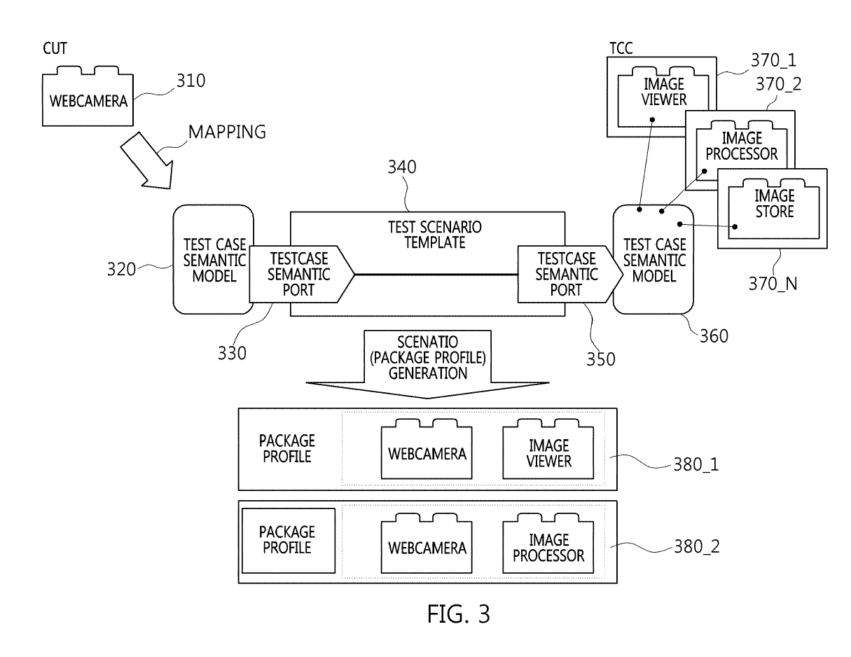

FIG. 2 is a flowchart for explaining a method for generating a scenario for testing the interoperability of robot software according to an embodiment of the present invention, and FIG. 3 is a view for explaining the operation mechanism of an apparatus for generating a scenario for testing the interoperability of robot software according to an embodiment of the present invention.

First, the apparatus 100 for generating an interoperability test scenario receives a request for testing at step S210.

The apparatus 100 for generating an interoperability test scenario receives a test request including a component under test in order to test the interoperability of multiple robot software components that have no settled interface specifications. Here, the apparatus 100 for generating an interoperability test scenario may receive the test request from a user through a user interface.

Then, the apparatus 100 for generating an interoperability test scenario maps the component under test to a test case semantic model at step S220.

As illustrated in FIG. 3, the apparatus 100 for generating an interoperability test scenario maps the component under test (CUT) 310 to a test case semantic model 320, corresponding to components that perform a function the same as or similar to that of the component under test 310. Here, the apparatus 100 for generating an interoperability test scenario may map the component under test to the test case semantic model 320 through the interaction with a user via a user interface.

Also, the apparatus 100 for generating an interoperability test scenario may map the component under test 310 to a test case semantic model 320 corresponding to the types of the component under test 310 and the input/output port of the component under test 310. Also, the apparatus 100 for generating an interoperability test scenario may map the component under test 310 to one or more test case semantic models 320.

As described above, the apparatus 100 for generating an interoperability test scenario may map the component under test 310 to the test case semantic model 320 corresponding to components that perform a function the same as or similar to that of the component under test 310. For the convenience of description, the test case semantic model 320 mapped to the component under test 310 is called a component under test semantic model.

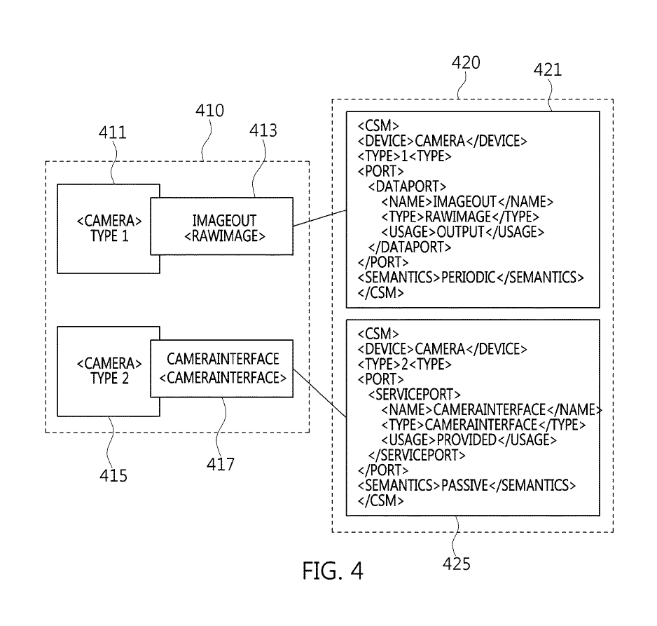

FIG. 4 is a view for explaining a semantic model and a semantic model description file according to an embodiment of the present invention.

As illustrated in FIG. 4, a semantic model 410 for a camera component may include a first semantic model 411 and a second semantic model 415. The first semantic model 411 may include a port (ImageOut) 413, which outputs data having the type of RawImage, and the description of the port 413 of the first semantic model may be included in a first description file 421.

The second semantic model 415 may include a port (CameraInterface) 417, which provides a service having the type of CameraInterface, and the description of the port 417 of the second semantic model may be included in a second description file 425.

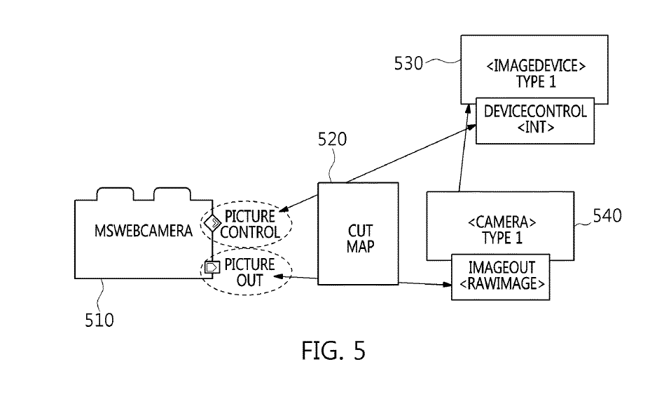

FIG. 5 is a view for explaining the relationship between a test case semantic model and a component under test according to an embodiment of the present invention.

The component under test 510 may be mapped to one or more test case semantic models 530 and 540 based on a Component Under Test Mapping Profile (CUT Map) 520.

As illustrated in FIG. 5, an association between the component under test 510 and each of the first test case semantic model (ImageDevice) 530 and the second test case semantic model (Camera) 540 may be set through the CUT Map 520.

Here, the CUT Map 520 may be generated when a request to test the component under test 510 is received. When the test case semantic models 530 and 540 having semantic similarity with the component under test 510 are selected in consideration of the type of the component under test 510 and the input/output port of the component under test 510, the CUT Map 520 in the form of file, in which information for connecting the component under test 510 with the selected test case semantic models is included, may be generated.

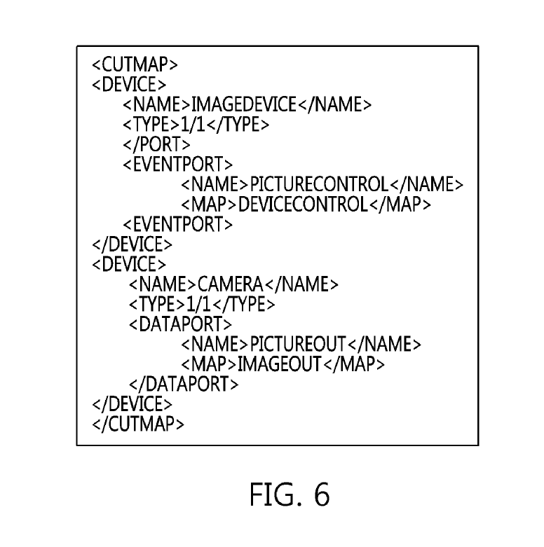

FIG. 6 is a view for explaining a mapping file of a component under test according to an embodiment of the present invention.

As illustrated in FIG. 6, a mapping file of the component under test (CUT) may include information, such as the names of test case semantic models (ImageDevice and Camera) corresponding to the component under test, the names of ports (PictureControl and PictureOut) of the component under test, and the names of ports (DeviceControl and ImageOut) of the test case sematic models, wherein the ports of the test case semantic models are mapped to the respective ports of the component under test.

As described above, because components created by different producers may be mapped to a test case semantic model, even if the names of the actual components or the names of the ports thereof differ from each other, the components may be accessed using the same component name or the same port name from the aspect of the test case semantic model, and a test case may be abstracted.

Referring again to FIG. 2, the apparatus 100 for generating an interoperability test scenario selects a test scenario template at step S230.

The apparatus 100 for generating an interoperability test scenario selects a test scenario template 340 corresponding to the type of the component under test 310 from among test scenario templates stored in a test scenario template repository.

In order to solve the problem with the existing technology, in which a large amount of resources may be expended because a test case for testing the interoperability between components is generated for the actual components whenever a test is performed, the apparatus 100 for generating an interoperability test scenario according to an embodiment of the present invention defines a test scenario template 340.

Here, the test scenario template 340 defines a connection between different test case semantic models 320 and 360. In fact, the test scenario template 340 may define a connection between semantic ports 330 and 350 on the test case semantic models 320 and 360.

Also, the test scenario template 340 may include a method for setting a connection between components using the test case semantic models 320 and 360 corresponding thereto based on the semantic information of the semantic ports on the respective test case semantic models.

Here, when the type of the component under test 310 is the same as the type of a component corresponding to a source or a target in the test scenario template, the apparatus 100 for generating an interoperability test scenario may determine that the corresponding test scenario template 340 is matched with the component under test 310, and may select the test scenario template 340.

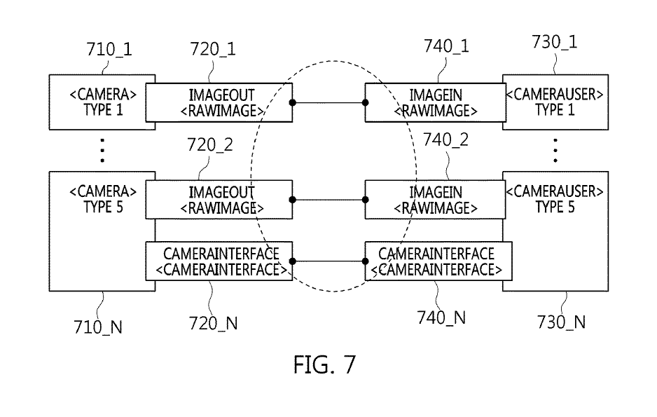

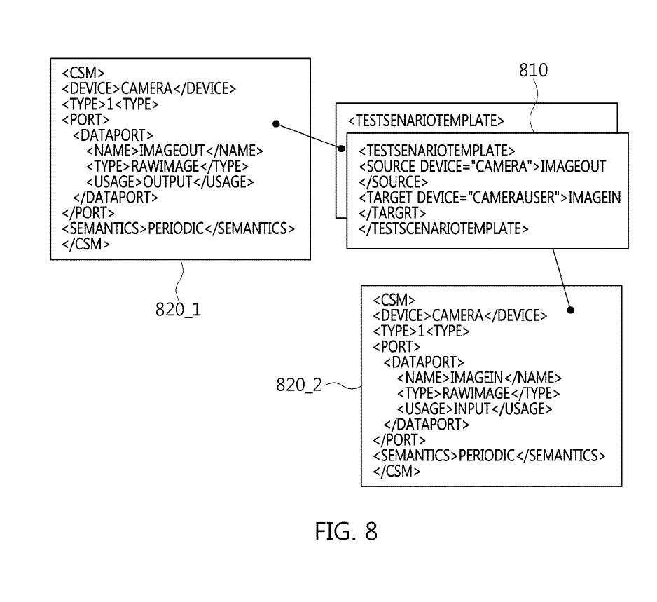

FIG. 7 is a view for explaining a connection of test case semantic models according to an embodiment of the present invention, and FIG. 8 is a view for explaining a test case semantic model description file and a test scenario template according to an embodiment of the present invention.

As shown in FIG. 7, test case semantic models 710 corresponding to a Camera component, which is an image-capture device, may be configured differently depending on the type and configuration of the input/output port 720 of the Camera component.

Also, test case sematic models 730 corresponding to a CameraUser component, which uses data output from an image-capture device, may be configured differently depending on the type and configuration of the input/output port 740 of the CameraUser component.

Here, a semantic model description file 820 containing the specifications of the test case semantic models 710 and 730 may comprise as many semantic model description files as the number of types of test case semantic models, as shown in FIG. 8.

Also, the test scenario template 810 defines a connection rule between the ports 720 and 740 on the test case semantic models 710 and 730. For example, the connection rule may be defined such that, when the type of the component is Camera and the type of the port to be connected is ImageOut at the source side, corresponding to the starting point of the connection, the type of the component is CameraUser and the type of the port to be connected is ImageIn at the target side, corresponding to the end point of the connection, as shown in FIG. 8.

Here, in the test scenario template 810, Camera, defined in Device in the source, must be present with the same name in the port in the semantic model description file 820. Also, CameraUser, defined in Device in the target, must be present with the same name in the port in the semantic model description file 820.

Referring again to FIG. 2, the apparatus for generating an interoperability test scenario selects a test case component at step S240.

When the component under test 310 is mapped to the test case semantic model 320 corresponding to a source in the test scenario template 340, the apparatus 100 for generating an interoperability test scenario may select the component mapped to the component type of a target as a Test Case Component (TCC) 370.

Also, when the component under test 310 is mapped to the test case semantic model 320 corresponding to a target in the test scenario template 340, the apparatus 100 for generating an interoperability test scenario may select the component mapped to the component type of a source as the test case component 370.

Here, the apparatus 100 for generating an interoperability test scenario may select one or more test case components 370 from among multiple components stored in a component repository.

Finally, the apparatus 100 for generating an interoperability test scenario generates an interoperability test scenario at step S250.

The apparatus 100 for generating an interoperability test scenario generates an interoperability test scenario 380 in which the component under test is connected with test case components based on the connection information in the test scenario template 340.

Also, the apparatus 100 for generating an interoperability test scenario may generate a script that includes a series of instructions for executing the generated interoperability test scenario 380.

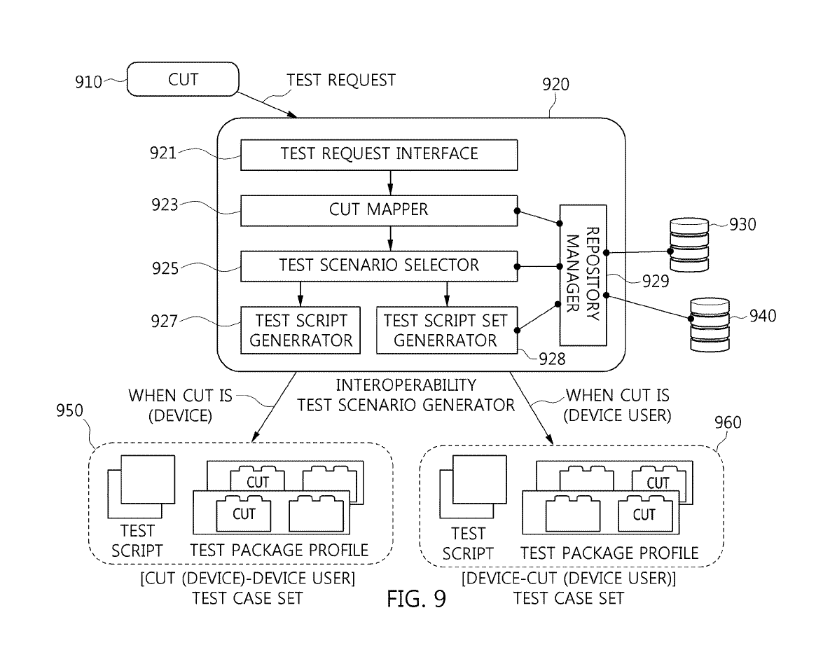

Hereinafter, the operation of an apparatus for generating an interoperability test scenario according to an embodiment of the present invention will be described in detail with reference to FIG. 9.

FIG. 9 is a view for explaining the operation of an interoperability test scenario generator according to an embodiment of the present invention.

As illustrated in FIG. 9, the interoperability test scenario generator 920 receives a component under test 910. Here, the interoperability test scenario generator 920 may receive a test request through a test request interface 921.

Also, the CUT mapper 923 of the interoperability test scenario generator 920 maps the component under test 910 to a test case semantic model.

Also, the test scenario selector 925 of the interoperability test scenario generator 920 selects a test scenario template corresponding to the type of the component under test 910.

Next, the test script generator 927 and the test scenario generator 928 of the interoperability test scenario generator 920 generate a script 950 and an interoperability test scenario 960, respectively.

Here, the interoperability test scenario generator may generate an interoperability test scenario using test case components and a test scenario template, stored in a component repository 930 and a test scenario template repository 940, through a repository manager 929.

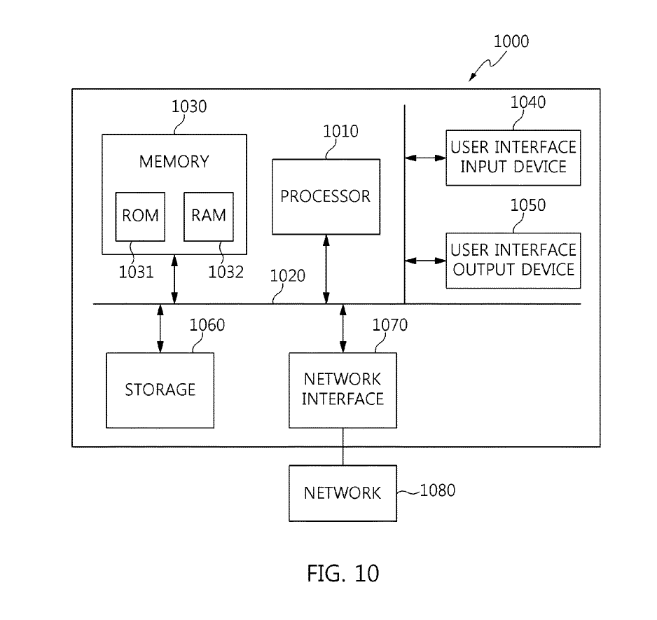

FIG. 10 is a block diagram that shows a computer system according to an embodiment of the present invention.

Referring to FIG. 10, an embodiment of the present invention may be implemented in a computer system 1000 such as a computer-readable recording medium. As illustrated in FIG. 10, the computer system 1000 may include one or more processors 1010, memory 1030, a user interface input device 1040, a user interface output device 1050, and storage 1060, which communicate with each other via a bus 1020. Also, the computer system 1000 may further include a network interface 1070 connected with a network 1080. The processor 1010 may be a central processing unit or a semiconductor device for executing processing instructions stored in the memory 1030 or the storage 1060. The memory 1030 and the storage 1060 may be different forms of volatile or non-volatile storage media. For example, the memory may include ROM 1031 or RAM 1032.

Accordingly, an embodiment of the present invention may be implemented as a non-temporary computer-readable storage medium in which methods implemented using a computer or instructions executable in a computer are recorded. When the computer-readable instructions are executed by a processor, the computer-readable instructions may perform a method according to at least one aspect of the present invention.

According to the present invention, robot software components on which an interoperability test may be performed may be automatically selected.

Also, according to the present invention, it is possible to automatically generate an interoperability test scenario for robot software components, in which information for setting a connection between ports of the software components is automatically included.

Also, according to the present invention, it is possible to improve the efficiency of use of time and human resources required for an interoperability test performed on a large number of software components.

As described above, the apparatus and method for generating a scenario for testing the interoperability of robot software according to the present invention are not limitedly applied to the configurations and operations of the above-described embodiments, but all or some of the embodiments may be selectively combined and configured, so that the embodiments may be modified in various ways.

What is claimed is:

1. An apparatus for generating a scenario for testing interoperability of robot software, comprising:
a user interface unit for receiving a request to test a component under test from a user;
a semantic model-mapping unit for mapping a test case semantic model to the component under test;
a test scenario template selection unit for selecting a test scenario template corresponding to a type of the component under test;
a test case component selection unit for selecting a test case component based on whether the mapped test case semantic model corresponds to a source or a target; and
an interoperability test scenario generation unit for generating an interoperability test scenario based on information about a connection between the component under test and the test case component in the selected test scenario template.

2. The apparatus of claim 1, wherein the sematic model-mapping unit maps the test case semantic model, corresponding to types of the component under test and an input/output port of the component under test, to the component under test.

3. The apparatus of claim 1, wherein the test scenario template includes a connection between a semantic port of the test case sematic model, mapped to the component under test, and a semantic port of a test case semantic model corresponding to the test case component.

4. The apparatus of claim 3, wherein the test scenario template selection unit selects the test scenario template when a type of the component under test is identical to a type of a component corresponding to a source in the test scenario template.

5. The apparatus of claim 3, wherein the test scenario template selection unit selects the test scenario template when a type of the component under test is identical to a type of a component corresponding to a target in the test scenario template.

6. The apparatus of claim 1, wherein the test case component selection unit selects the test case component corresponding to the source when the test case semantic model mapped to the component under test corresponds to the target in the test scenario template.

7. The apparatus of claim 1, wherein the test case component selection unit selects the test case component corresponding to the target when the test case semantic model mapped to the component under test corresponds to the source in the test scenario template.

8. The apparatus of claim 1, wherein the interoperability test scenario is generated by connecting the component under test with the test case component in the selected test scenario template.

9. The apparatus of claim 1, wherein the component under test is mapped to the one or more test case semantic models.

10. The apparatus of claim 1, wherein the interoperability test scenario generation unit generates a script including instructions for executing the generated interoperability test scenario.

11. A method for generating a scenario for testing interoperability of robot software, performed by an apparatus for generating a scenario for testing interoperability of robot software, comprising:
receiving a request to test a component under test from a user;
mapping a test case semantic model to the component under test;
selecting a test scenario template corresponding to a type of the component under test;
selecting a test case component based on whether the mapped test case semantic model corresponds to a source or a target; and
generating an interoperability test scenario based on information about a connection between the component under test and the test case component in the selected test scenario template.

12. The method of claim 11, wherein mapping the test case semantic model is configured to map a test case semantic model, corresponding to types of the component under test and an input/output port of the component under test, to the component under test.

13. The method of claim 11, wherein the test scenario template includes a connection between a semantic port of the test case sematic model, mapped to the component under test, and a semantic port of a test case semantic model corresponding to the test case component.

14. The method of claim 13, wherein selecting the test scenario template is configured to select the test scenario template when a type of the component under test is identical to a type of a component corresponding to a source in the test scenario template.

15. The method of claim 13, wherein selecting the test scenario template is configured to select the test scenario template when a type of the component under test is identical to a type of a component corresponding to a target in the test scenario template.

16. The method of claim 11, wherein selecting the test case component is configured to select the test case component corresponding to the source when the test case semantic model mapped to the component under test corresponds to the target in the test scenario template.

17. The method of claim 11, wherein selecting the test case component is configured to select the test case component corresponding to the target when the test case semantic model mapped to the component under test corresponds to the source in the test scenario template.

18. The method of claim 11, wherein the interoperability test scenario is generated by connecting the component under test with the test case component in the selected test scenario template.

19. The method of claim 11, wherein the component under test is mapped to the one or more test case semantic models.

20. The method of claim 11, wherein generating the interoperability test scenario is configured to generate a script including instructions for executing the generated interoperability test scenario.
